(19) United States
(12) Patent Application Publication
(10) Pub. No.: US 2026/0110176 A1
(43) Pub. Date: Apr. 23, 2026

(54) METHOD AND KIT COMPOSITIONS FOR REJUVENATING ASPHALT ROOF SHINGLES

(71) Applicant: Spray-Net Franchises Inc., Boucherville (CA)

(72) Inventors: Peiman ARABI, Boucherville (CA); Carmelo MARSALA, Boucherville (CA)

(73) Assignee: Spray-Net Franchises Inc., Boucherville (CA)

(21) Appl. No.: 19/364,601

(22) Filed: Oct. 21, 2025

Related U.S. Application Data
(60) Provisional application No. 63/710,221, filed on Oct. 22, 2024.

(51) Int. Cl. E04D 1/20; C08L 95/00; C09D 7/61; C09D 7/63; C09D 195/00; C09J 167/08

(52) U.S. Cl. CPC E04D 1/20; C08L 95/005; C09D 7/61; C09D 7/63; C09D 195/005; C09J 167/08; C08L 2555/64

(57) ABSTRACT

A method and a kit for rejuvenating shingles of a roof is disclosed. The method comprises: applying a first composition on an outer surface of said shingles for softening and making them flexible; coating the first composition with a second composition; and applying over the second composition a third composition configured to mechanically reinforce the softened flexible roof shingles. The second composition is configured to provide adhesion between the first and third composition. The rejuvenated asphalt shingles according to the present invention show similar impact resistance, lower granule loss, resistance against wind, and no adverse impact by fungi compared to new/original shingles. The method and kit as described herein allows rejuvenating the shingles, saving as such time and important costs compared to the entire replacement of the old shingles by new ones.

### CROSS-REFERENCE TO RELATED APPLICATIONS

The present patent application claims the benefit of priority of U.S. Provisional Patent Application No. 63/710,221 entitled “METHOD AND KIT COMPOSITIONS FOR REJUVENATING ASPHALT ROOF SHINGLES” and filed at the United States Patent and Trademark Office on Oct. 22, 2024, the content of which is incorporated herein by reference.

### FIELD OF THE INVENTION

The present invention generally relates to products and methods for rejuvenating aged roofs, particularly useful for rejuvenating roof components such as asphalt roof shingles.

### BACKGROUND OF THE INVENTION

Asphalt based shingles are the most common roofing material used in Canada and the United States on residential and commercial structures. These asphalt shingles are composed of a thin and flat base material made of either paper or fiberglass, which is saturated with asphalt. Granular material is embedded on the upper surface of the asphalt saturated base material. The durability of these shingles is ranked by the warranted life of the materials, and the life span of such shingles can range from 5 to 60 years.

There are a number of ways an asphalt shingle can be damaged, and most of these damages will result in the loss of protection to the underlying structure. Typical damages could be caused by:
normal ageing of the shingles,
mechanical damage from foot traffic,
UV effect and loss of plasticizing properties;
shingle manufacturing defects such as blistering, and
damages resulting from weather conditions such as high winds, heavy rain, or hail.

Hail and similar weather-related damage are estimated to cause more than one billion dollars in roof damage in the United States only each year. The type of roofing materials affected the most by hail damage is asphalt-based roofing shingles with embedded granules. Such hail damage to asphalt shingles may include: (1) dislodging the granular material on the top surface of the asphalt base, (2) causing indentions in the asphalt, or (3) puncturing a hole or gash into the asphalt shingle.

For weather-related damage, dislodging of the granular material from the top surface of the asphalt shingle may sound innocuous, but the resulting damage caused by dislodging the granular material is significant. The granules embedded on the top surface of an asphalt shingle have a two-fold purpose. While the granules provide color for the aesthetic appearance of the roof, the granules are essential to providing the durability of the roofing shingle by providing weather resistance and protection from ultra-violet (UV) radiation.

If granules are removed from the top surface of an asphalt shingle, the shingle will be more vulnerable to subsequent weather damage and increased UV radiation. Over time, increased UV radiation and heat applied by the sun against the unprotected shingle will cause the exposed asphalt areas under the top surface of the asphalt shingle to dry and become brittle and subsequently curl or crack. A dry, curled or cracked underlying asphalt shingle will likely lead to leak damage of the roof, and destruction of the roof sheathing residing under the shingles. Eventually, this type of damage will compromise the underlying housing structure.

When a portion of the roofing shingles on a roof becomes damaged (e.g. by high winds, hail damage, etc.), replacement of the entire roof is usually recommended. This is the normal recommendation even for relatively minor indentions if there is sufficient loss of granules over a pre-determined area of the roof. Entire roof replacement for this type of weather-related damage is responsible for the majority of roof-related insurance payouts by homeowner insurance companies. One of the consequences of this type of roof replacement is that massive amounts of shingles, in the order of billion pounds, are deposited in landfills each year, even though many or most of those shingles are in a good or undamaged condition.

Therefore, there is a need for a method that can avoid the replacement of an entire shingled roof but rather prevent damages on shingles such that the restored and/or rejuvenated roof shingles are fully functional and mechanically reinforced against future damages. Also, the required method needs to maintain original shingles' aesthetics.

### SUMMARY OF THE INVENTION

The above shortcomings are generally mitigated by a new method for rejuvenating a roof of a building and multiple new coating formulations to be applied to asphalt shingles providing weather resistance and protection while preserving building's aesthetics, such as color and texture.

According to a first aspect of the invention, a method is presented for rejuvenating asphalt shingles affixed to a roof, the method comprising:
applying a first composition on an outer surface of said shingles for softening and making the said shingles flexible;
optionally, mechanically flattening the softened shingles;
coating the softened shingles with a second composition; and
applying a third composition over the second composition, the third composition being configured to mechanically reinforce the softened shingles;
wherein the second composition is configured to provide adhesion between the shingles softened by the first composition and the third composition

According to a second aspect of the invention, a kit is presented for rejuvenating asphalt shingles affixed to a roof, the kit comprising:
a first container comprising a first composition configured to be applied on an outer surface of said shingles for softening and making said roof shingles flexible;
a second container comprising a second composition for coating the softened shingles; and
a third container comprising a third composition configured to be applied over the second composition, the third composition being configured to mechanically reinforce the softened shingles;
wherein the second composition is configured to provide adhesion between the shingles soften by the first composition and the third composition.

According to a third aspect of the invention, a composition for providing adhesion between softened shingles and a mechanical reinforcement agent is presented, the composition comprising: a water-reducible alkyd resin; and a mineral filler, the mineral filler comprising particles having a median particle size from about 50 μm to about 110 μm.

The methods and kits as disclosed herein allow rejuvenating asphalt-based shingles. Advantageously, the methods and kits as described herein use a combination of a first, second and third compositions, wherein a strong adhesion is provided between the first composition and the third composition thanks to the second composition therebetween. The rejuvenated asphalt shingles according to the present invention show similar impact resistance, lower granule loss, resistance against wind, and no adverse impact by fungi compared to new/original shingles. The method and kit as described herein allow rejuvenating the shingles, thereby protecting them against several types of damages, saving as such time and important costs compared to the entire replacement of the old shingles by new ones.

Other and further aspects and advantages of the present invention will be better understood upon the reading of the illustrative embodiments about to be described or will be indicated in the appended claims, and various advantages not referred to herein will occur to one skilled in the art upon employment of the invention in practice.

### BRIEF DESCRIPTION OF THE DRAWINGS

The above and other aspects, features and advantages of the invention will become more readily apparent from the following description, reference being made to the accompanying drawings in which:

FIG. 1 is a schematic illustration of a rejuvenated roof shingle using the method according to a preferred embodiment of the present invention showing different coating composition layers;

FIGS. 2A-B show comparative results of the wind resistance test according to ASTM D3161 for untreated and rejuvenated roof shingles, respectively;

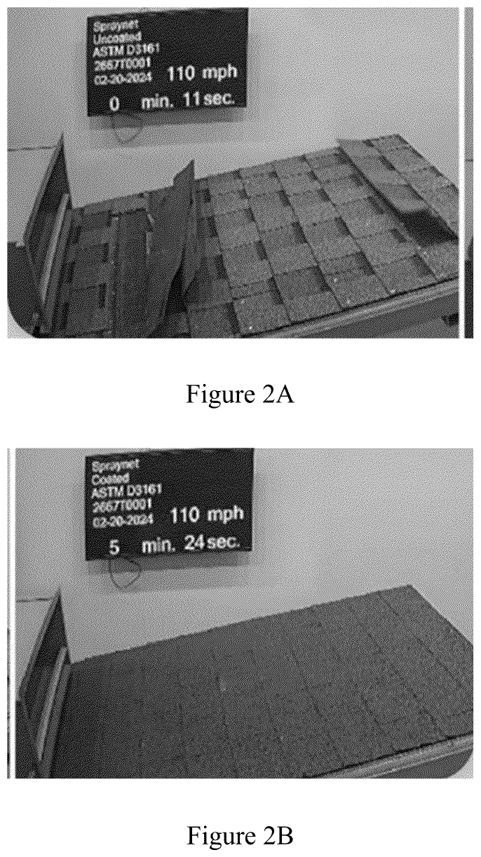

FIGS. 3A-B show comparative results of the granule loss test according to ASTM D4977 for untreated and rejuvenated roof shingles, respectively; and

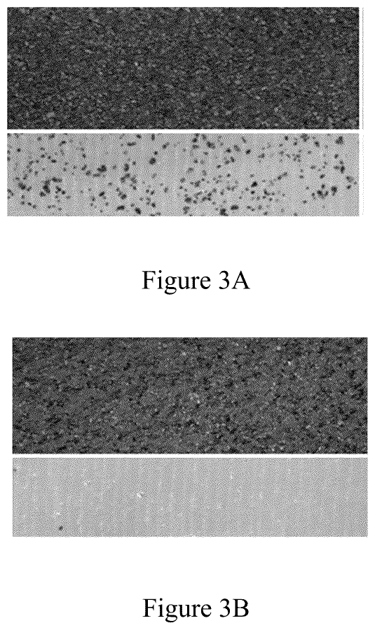

FIGS. 4A-C show comparative results of the impact resistance test according to ANSI/UL 2218 for untreated roof shingles (4A and 4B at various locations) and rejuvenated roof shingles (4C), respectively.

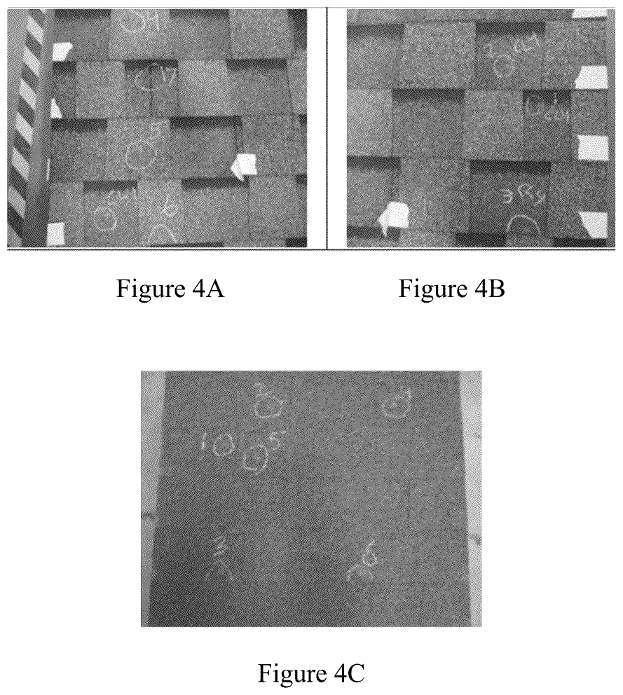

### DETAILED DESCRIPTION OF THE PREFERRED EMBODIMENT

A novel roof coating method and related compounds for rejuvenating a roof of a building will be described hereinafter. Although the invention is described in terms of specific illustrative embodiments, it is to be understood that the embodiments described herein are by way of example only and that the scope of the invention is not intended to be limited thereby.

The terminology used herein is in accordance with definitions set out below.

As used herein % or wt. % means weight % unless otherwise indicated. When used herein % refers to weight % as compared to the total weight percent of the phase or composition that is being discussed. Unless otherwise indicated in the present invention, the compounds or products used herein are measured in weight.

By “about”, it is meant that the value of a data can vary within a certain range depending on the margin of error of the method or device used to evaluate such data. A margin of error of 10% is generally accepted.

By “roof shingle” or “asphalt roof shingle” or “asphalt shingle”, which can be used interchangeably, it is meant roof coverings consisting of individual overlapping elements which are typically flat, rectangular shapes laid in courses from the bottom edge of the roof up, with each successive course overlapping the joints below. Shingles can be made of various materials such as wood, slate, flagstone, metal, plastic, and composite materials such as fibre cement and asphalt shingles.

By “roof rejuvenation”, it is meant a method that restores and/or improves the mechanical properties of the roof component, such as roof shingles, that have been damaged over time due to factors such as ageing, weather conditions, etc., improve protection against physical impacts and increases their durability against said factors while maintaining the aesthetic aspect of the roof components.

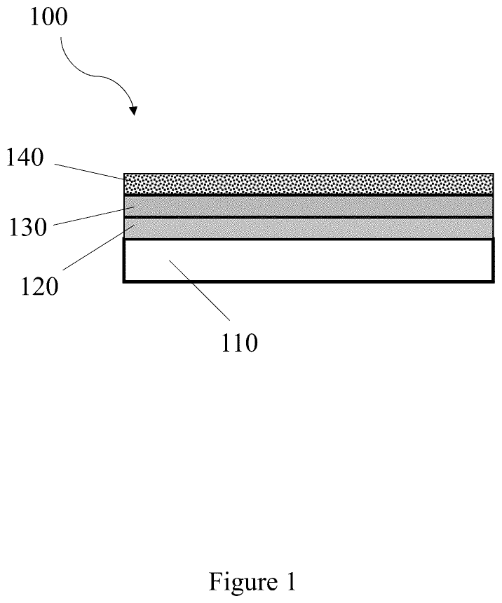

FIG. 1 is a schematic illustration of a rejuvenated roof shingle using the method according to a preferred embodiment of the present invention showing different coating composition layers.

The rejuvenated roof shingle 100 comprises a base 110 which is the roof shingle that was curled and brittle and needs rejuvenation. In some embodiments, the roof shingles have also lost granules due to environmental conditions detailed above, leading to more porous non-water-proof sections of the roof.

At the first step of the method according to the present invention, a first composition is applied on an outer surface of the roof shingle as the first coating layer 120. The first composition is an emulsion-based coating that prepares the roof shingles for a complete treatment. Application of the first composition (i.e. the emulsion-based coating) results in a uniform oily coating over the roof shingles and the oily phase also partly diffuses into the matrix of said roof shingles thereby softening the curly and brittle roof shingles. In other words, the emulsion-based coating acts as a softening agent. Within the context of this description, the terms first composition, emulsion-based coating and softening agent may be used interchangeably.

The emulsion-based coating (softening agent) according to the present invention mainly comprises i) water in an amount ranging from about 40 to about 60 weight % and ii) a soy-based oil in an amount ranging from about 15 wt. % to about 35 wt. % which are then mixed in the presence of a non-ionic surfactant in an amount ranging from about 2 to about 5 weight %. Preferably, the soy-based oil is methylated soybean oil and the non-ionic surfactant is Polysorbate80.

In some embodiment, the emulsion-based coating (softening agent) may further comprise a complementary emulsifier such as Sorbitan Monooleate.

In some embodiment, the emulsion-based coating (softening agent) may further comprise a rheology modifier and/or a rheology additive to adjust the coating viscosity. Examples of rheology modifier and rheology additive may be an acrylic thickener and a polyacrylate, respectively.

In some embodiment, the emulsion-based coating (softening agent) may further comprise an asphalt emulsion. The asphalt emulsion may serve a dual function of acting as a binder in the formulation and restoring flexibility of dried shingles by replenishing shingles' lost petroleum or oil content thereby rejuvenating the shingles with an overall effect of enhanced durability.

In some embodiment, the emulsion-based coating (softening agent) may further comprise a defoaming agent configured to eliminate any trapped air or foam that may form during application of the first composition (i.e. the softening agent), ensuring a smooth and defect-free finish. That is to say, the main function of the defoaming agent is to prevent and reduce foam, which can negatively impact the uniformity and adhesion of the softening agent on the shingle surface. In a preferred embodiment, the defoaming agent is a modified polyether urethane.

Returning to FIG. 1, the softened roof shingles, upon application of the softening agent over said roof shingles, are now coated with a second composition 130 that tops the first composition 120. The main function of the second composition, which is also called a middle coating, is to provide an enhanced adhesion between the softened shingles and the reinforcing agent which will be further described in the text. Within the context of this description, the terms second composition and middle coating may be used interchangeably.

The middle coating according to the present invention mainly comprises i) a resin in an amount ranging from about 40 to about 60 weight % and ii) mineral fillers in an amount ranging from about 20 to about 40 weight %. Preferably, the resin is a water-reducible alkyd resin and the mineral filler is MINEX® produced from nepheline syenite; a naturally occurring, silica deficient, sodium-potassium alumina silicate. Preferably, different grades of MINEX® (different particle size distribution) are used in the middle coating composition.

Finally, the softened roof shingle that was coated with the middle coating is then coated with a third composition 140. The third composition is a water-based coating that tops the middle coating and is configured to reinforce and protect the shingles against damages and granule loss and fully bond to the softening agent thanks to binding/adhesion provided by the middle coating. In other words, the third composition acts as a reinforcing agent. Within the context of this description, the terms third composition and reinforcing agent may be used interchangeably.

The composition of the water-based coating that is applied on the top of the middle coating is disclosed fully in U.S. Pat. No. 12,286,553 by Arabi et al., the content of which is incorporated by reference in entirety. The water-based coating that tops the middle coating has shown to have a strong adhesion to the oily, softened shingles thanks to the middle coating that facilitates such adhesion.

The water-based coating composition comprises a pre-mix base composition, also named herein the “clear base” (CB), which is generally mixed on site (i.e. where the roof to be rejuvenated is located) with an amount of roofing solid granules (CR) before being sprayed on the roof surface using a spraying gun. The roofing solid granules may comprise ceramic granules, amorphous aluminum silicate, or the like, or mixture thereof. The ratio clear base composition (CB)/roofing solid granules (CR) is about 1/1 to ½, preferably from 1/1.1 to 1/1.5, more preferably 2/3 (or 1/1.5) all in wt. %.

The base composition once mixed with roofing ceramic granules may provide a coating texture comparable to the texture of the original shingles to be coated.

The base composition comprises as a main component a water based polymeric emulsion or resin adapted for providing strong adhesion to most architectural roofs or facades. Preferably, the emulsion is an acrylic polyurethane hybrid emulsion, such as Carboset® by Lubrizol or RHOPLEX™ by Dow or EPS® 2719.

A mattifying agent and filler are added to the base composition to mattify the resulting coating which is otherwise too shiny (gloss). Examples of mattifying agent comprises treated silica, amorphous aluminum silicate, sodium-potassium alumina silicate, or the like or mixtures thereof.

The water-based coating composition may further comprise a thickener or rheology modifier to adjust the viscosity of the coating composition and allow the coating composition containing the granules to be sprayed on a surface with a spraying gun. The viscosity is measured according to ASTM D562: Standard Test Method for Consistency of Paints Measuring Krebs Unit (KU) Viscosity Using a Stormer-Type Viscometer. A viscosity of the coating composition of about 100-140 KU, preferably about 125-135 KU, is particularly adapted for spraying application. For example, hydrophobically modified ethylene oxide urethane (also known as hydrophobicaly modified urethane-ethoxylate or HEUR) or a solution of a urea-modified polyurethane can be used. The invention is not limited to the nature of the viscosity modifier.

The water-based coating composition may further comprise a defoamer agent, such as a silicone-containing defoamer. For example, the defoamer agent can be an emulsion of polyether-modified polydimethylsiloxane with hydrophobic solids.

The water-based coating composition may further comprise at least one solvent such as, but not limited to water (H₂O), Texanol™ (2,2,4-Trimethyl-1,3-pentanediol monoisobutyrate), Ethylene glycol monobutyl ether, or a mixture thereof. The solvents and the rheology modifier agent form a coalescing agent.

The water-based coating composition may further comprise at least one biocide such as fungicide, algicide (or algaecide), or the like. The invention is not limited to the nature of the biocide agent.

The water-based coating composition may further comprise at least one antifreeze agent, such as, but not limited to ethylene glycol (ethane-1,2-diol). The invention is not limited to the nature of the antifreeze agent.

The water-based coating composition may further comprise at least one light stabilizer, such as but not limited to hindered-amine light stabilizers (HALS). The invention is not limited to the nature of the light stabilizer.

The water-based coating composition may further comprise at least one UV absorber, such as, but not limited to 2-hydroxy-phenyl-s-triazine (HPT), Tinuvin® (2-[4-[(2-Hydroxy-3-dodecyloxypropyl)oxy]-2-hydroxyphenyl]-4,6-bis(2,4-dimethylphenyl)-1,3,5-triazine and 2-[4-[(2-Hydroxy-3-tridecyloxypropyl)oxy]-2-hydroxyphenyl]-4,6-bis(2,4-dimethylphenyl)-1,3,5-triazine (1-methoxy-2-propanol 15%)), or mixture thereof. The invention is not limited to the nature of the UV absorber.

The inventors of the present invention have identified for the first time that using a middle coating (second composition) between the softening agent (first composition) and the reinforcing agent (third composition) would be advantageous as the middle coating allows adhesion between the softening agent and reinforcing agent.

Using a softening agent that is strongly bonded to the reinforcing agent thanks to a middle coating, which acts as a binder brings an unexpected technical advantage in that the rejuvenated roof shingles exhibit an improved mechanical performance. In other words, and specific to desired mechanical specifications, the roof shingles that are rejuvenated by the method according to the present invention can better withstand ageing, wind, hail, etc., and will better preserve their granule content over long periods of time.

The person skilled in the art would readily understand that while FIG. 1 shows a side cut of one single rejuvenated roof shingle, the method according to the present invention is also applicable to an array or a plurality of roof shingles as well.

Following Examples, will present possible compositions of the first and second compositions as well as test results that demonstrate enhanced mechanical properties of rejuvenated roof shingle.

### Example 1: First Composition or Emulsion (Softening Agent)

In Example 1, the emulsion-based coating (softening agent) can be prepared from the components listed in Table 1 and according to the steps disclosed below.

TABLE 1

| | Percentage |
|---|---|
| Component | Range (wt. %) |
| Water | 40-60 |
| Nonionic Surfactant (e.g Polysorbate 80) | 2-5 |
| Oil phase (e.g. Methylated Soybean Oil) | 15-35 |
| Surfactant (e.g. Sorbitan Monooleate) | 1-4 |
| Defoaming Agent (e.g. Modified Polyether | 0.5-2 |
| Urethane) | |
| Asphalt Emulsion | 10-25 |
| Rheology Modifier (e.g. Acrylic Thickener | 0.5-2 |

First step, water and non-ionic surfactant are mixed together to obtain a first mixture.

Second step, the methylated soybean oil and sorbitan monooleate are mixed to obtain a second mixture.

Third step, the first and second mixture are mixed to obtain a third mixture.

Finally, in a fourth step, the defoaming agent, asphalt emulsion, rheology modifier and rheology additive are added to the third mixture to obtain the softening agent.

In some embodiments, the defoaming agent is BYK-015® and/or BYK-012® from BYK additives.

In embodiments, the asphalt emulsion is an anionic water-based asphalt emulsion from Coco Asphalt Engineering.

In embodiments, the rheology modifier is Acrysol® RM8W or Acrysol® RM12W from Dow.

### Example 2: Emulsion-Based Coating (Softening Agent) Performance

The performance of the softening agent can be evaluated. The purpose of the evaluation is to ensure that the softening agent has properly diffused and penetrated into the curled and brittle shingles to soften them. The relevant performance test in this Example is a pliability test according to ASTM D3462 titled Standard Specification for Asphalt Shingles Made from Glass Felt and Surfaced with Mineral Granules. This test includes an evaluation of the bending flexibility of shingles that are coated with the emulsion-based coating (softening agent) i.e. the degree of bending the softened shingles can withstand without cracking or breaking. The result is in terms of pass/fail and upon visual inspection of the bended shingles. A pass result was observed for the softened shingles which was an indication of satisfactory penetration of the softening agent into the shingle matrix.

The purpose of the performance evaluation is to further ensure that the softening agent has properly diffused and penetrated into the curled and brittle shingles to soften them. The first step of the evaluation is based on visual observations to verify if the softened shingles are pliable. As for the second step of the evaluation, a bending (pliability) test is performed according to ASTM D3462 which is titled Standard Specification for Asphalt Shingles Made from Glass Felt and Surfaced with Mineral Granules. The test results showed improvements in pliability of softened shingles with visible reduction in cracking.

### Example 3: Middle Coating

In Example 3, the middle coating is prepared by mixing the ingredients listed in Table 2.

TABLE 2

| | Percentage |
|---|---|
| Component | Range (wt. %) |
| Water-Reducible Alkyd Resin | 40-60 |
| Defoamer (Polysiloxane) | 0.5-2 |
| Mineral Filler: MINEX ® median particle size: 50- | 20-40 |
| 110 μm | |
| Iron Oxide Pigment | 1-5 |
| Leveling Agent (e.g. Polyether Modified | 0.1-1 |
| Polydimethylsiloxane) | |
| Water | 1-3 |
| Coalescing Agent (e.g. 2,2,4-Trimethyl-1,3-pentanediol | 0.5-2 |
| Monoisobutyrate) | |
| Solvent (e.g. Dipropylene Glycol Methyl Ether) | 0.5-2 |
| Cellulose-Based Thickener | 1-5 |
| Rheology Modifier (Hydrophobically Modified Alkali- | 0.1-1 |
| Swellable Emulsion) | |

In some embodiments, the water-reducible Alkyd Resin is Uradil® AZ-760 and Uradil® AZ-800.

Without wishing to be bound by a theory, it is believed by the inventors that the presence of the mineral filler(s) in the middle coating recipe causes an improved bonding between the softened shingle and the water-based coating (reinforcing agent).

While illustrative and presently preferred embodiments of the invention have been described in detail hereinabove, it is to be understood that the inventive concepts may be otherwise variously embodied and employed and that the appended claims are intended to be construed to include such variations.

What is claimed is:

1. A method for rejuvenating asphalt shingles affixed to a roof, the method comprising:
applying a first composition on an outer surface of said shingles for softening and making said roof shingles flexible;
optionally, mechanically flattening the softened shingles;
coating the softened shingles with a second composition; and
applying a third composition over the second composition, the third composition being configured to mechanically reinforce the softened shingles;
wherein the second composition is configured to provide adhesion between the shingles softened by the first composition and the third composition.

2. The method according to claim 1, wherein the first composition is an emulsion comprising water, a soy-based oil and a surfactant.

3. The method according to claim 2, wherein the soy-based oil is methylated soybean oil.

4. The method according to claim 3, wherein the methylated soybean oil is present in the emulsion with a concentration ranging from about 15 wt. % to about 35 wt. %.

5. The method according to claim 2, wherein the surfactant in the emulsion is Polysorbate80.

6. The method according to claim 5, wherein the Polysorbate80 is present in the emulsion with a concentration ranging from about 2 wt. % to about 5 wt. %.

7. The method according to claim 1, wherein the second composition comprises a resin and a mineral filler.

8. The method according to claim 7, wherein the resin comprises alkyd resin.

9. The method according to claim 8, wherein the resin is present in the second composition with a concentration ranging from about 40 wt. % to about 60 wt. %.

10. The method according to claim 1, wherein applying the first composition comprises:
spraying the first composition on said shingles to entirely cover said shingles; and
letting the first composition to penetrate into said roof shingles.

11. A kit for rejuvenating asphalt shingles affixed to a roof, the kit comprising:
a first container comprising a first composition configured to be applied on an outer surface of said shingles for softening and making said roof shingles flexible;
a second container comprising a second composition for coating the softened shingles; and
a third container comprising a third composition configured to be applied over the second composition, the third composition being configured to mechanically reinforce the softened shingles;
wherein the second composition is configured to provide adhesion between the shingles soften by the first composition and the third composition.

12. The kit according to claim 11, wherein the first composition is an emulsion comprising water, a soy-based oil and a surfactant.

13. The kit according to claim 12, wherein the soy-based oil is methylated soybean oil, wherein the methylated soybean oil is present in the emulsion with a concentration ranging from about 15 wt. % to about 35 wt. %.

14. The kit according to claim 11, wherein the surfactant in the emulsion is Polysorbate80, wherein the Polysorbate80 is present in the emulsion with a concentration ranging from about 2 wt. % to about 5 wt. %.

15. The kit according to claim 11, wherein the second composition comprises a resin and a mineral filler.

16. The kit according to claim 15, wherein the resin comprises alkyd resin, and the mineral filler comprises particles having a median particle size from about 50 μm to about 110 μm.

17. The kit according to claim 16, wherein the resin is present in the second composition with a concentration ranging from about 40 wt. % to about 60 wt. %.

18. The kit according to claim 11, wherein the third composition comprises a pre-mix base and solid granules, the pre-mix base comprising:
a water based polymeric emulsion or resin adapted for adhering to the second composition; and
a rheology modifier agent adapted for adjusting a viscosity of the pre-mix base between about 100 KU and about 140 KU according to ASTM D562
wherein the pre-mix base and solid granules are mixed in a ratio of pre-mix base/solid granules ranging from 1/1 to ½ on a weight basis.

19. The kit according to claim 18, wherein the pre-mix base comprises from about 40 wt. % to about 95 wt. % of the water based polymeric emulsion or resin, and from 0.1 wt. % to 1.0 wt. % of the rheology modifier agent,
wherein the rheology modifier agent comprises a hydrophobically modified ethylene oxide urethane (HEUR), a solution of a urea-modified polyurethane, or a mixture thereof, and
wherein the solid granules density is from about 130 g/sq. ft. to about 170 g/sq. ft.

20. The kit according to claim 11, wherein the first container is configured for spraying the first composition on said shingles to entirely cover said shingles.

21. A composition for providing adhesion between softened shingles and a mechanical reinforcement agent, the composition comprising:
a water-reducible alkyd resin; and
a mineral filler comprising particles having a median particle size from about 50 μm to about 110 μm.

22. The composition according to claim 21, further comprising:
water;
a defoamer;
a leveling agent;
a coalescing agent;
a solvent;
a cellulose-based thickener; and/or
a rheology modifier.
